(19) United States
(12) Patent Application Publication
(10) Pub. No.: US 2025/0363521 A1
(43) Pub. Date: Nov. 27, 2025

(54) PERSONALIZED CAMPAIGN GENERATION THROUGH DEEP CUSTOMER LEARNING

(71) Applicant: INTUIT INC., Mountain View, CA (US)

(72) Inventors: Shon MENDELSON, Tel Aviv (IL); Yaakov TAYEB, Tel Aviv (IL); Sigalit BECHLER, Tel Aviv (IL); Kaaleb EDERY, Tel Aviv (IL)

(73) Assignee: INTUIT INC., Mountain View, CA (US)

(21) Appl. No.: 18/674,736

(22) Filed: May 24, 2024

(51) Int. Cl. G06Q 30/0242; G06Q 30/0241

(52) U.S. Cl. CPC G06Q 30/0244; G06Q 30/0243; G06Q 30/0246; G06Q 30/0276

(57) ABSTRACT

A system and method for generating and optimizing marketing campaigns. More specifically, a campaign management system leverages a Large Language Model (LLM) to create multiple variations of an existing campaign tailored to specific target groups. The system employs a cluster-based approach and a click-through rate (CTR) prediction model to generate revised campaigns for targeted readers, thereby creating a feedback loop for further fine-tuning of the LLM for future campaigns.

### BACKGROUND

In the field of digital marketing, campaign management systems are used to create, manage, and analyze advertising campaigns across various channels. One common approach is to use clustering algorithms to identify target groups within a reader audience based on features of the campaign. However, traditional campaign management systems have limitations. For instance, these systems typically require manual feature engineering to identify and incorporate meaningful feature interactions, which can be time-consuming and may not fully capture the nuances of user behavior—both of which are undesirable.

### SUMMARY

Embodiments disclosed herein solve the aforementioned technical problems and may provide other technical solutions as well. Contrary to conventional techniques, the disclosed solution includes a novel personalized campaign generator through deep customer learning.

An example embodiment includes a campaign management system, comprising: a campaign management server configured to receive a first campaign, execute a clustering algorithm to identify target groups within a reader audience based on features of the first campaign, provide a description of each identified target group via a characterization module, predict a probability of a reader clicking on a given campaign using a Click-Through Rate (CTR) prediction model, generate revised campaign candidates for each target group based on the first campaign and the target group description using a campaign generator, select a revised campaign that maximizes the predicted CTR with a selection module, and create a human-feedback dataset based on a performance of the revised campaign and fine-tune the campaign generator using a fine-tuning module with reinforcement learning, and a performance server in communication with the campaign management server, configured to collect campaign performance data and facilitate creation of the human-feedback dataset for adjusting the reinforcement learning.

An example embodiment includes a method for managing a campaign, comprising receiving a first campaign at a campaign management server, executing a clustering algorithm by the campaign management server to identify target groups within a reader audience based on features of the first campaign, providing a description of each identified target group via a characterization module of the campaign management server, predicting a probability of a reader clicking on a given campaign using a Click-Through Rate (CTR) prediction model of the campaign management server, generating revised campaign candidates for each target group based on the first campaign and the target group description using a campaign generator of the campaign management server, selecting a revised campaign that maximizes the predicted CTR with a selection module of the campaign management server, and creating a human-feedback dataset based on a performance of the revised campaign and fine-tuning the campaign generator using a fine-tuning module with reinforcement learning of the campaign management server, and collecting campaign performance data at a performance server in communication with the campaign management server and facilitating creation of the human-feedback dataset for adjusting the reinforcement learning.

### BRIEF DESCRIPTION OF THE DRAWINGS

So that the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may apply to other equally effective example embodiments.

FIG. 1 is a block diagram of an example campaign generation and management system, according to aspects of the present disclosure.

FIG. 2 is a flowchart illustrating an example process of optimizing a campaign generation, according to aspects of the present disclosure.

FIG. 3 is a flowchart illustrating an example process of identifying and characterizing target groups within the audience, according to aspects of the present disclosure.

FIG. 4 is a flowchart illustrating example steps taken during the campaign generation to create and select the revised campaigns, according to aspects of the present disclosure.

FIG. 5 is a flowchart illustrating an example feedback loop and learning process for improving the campaign generator, according to aspects of the present disclosure.

FIG. 6 is a block diagram of an example computing system, according to aspects of the present disclosure.

### DETAILED DESCRIPTION OF SEVERAL EMBODIMENTS

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatuses as known by one of ordinary skill in the relevant art may not be discussed in detail but are intended to be part of the specification where appropriate. In the examples illustrated and discussed herein, any specific values should be interpreted to be illustrative and non-limiting. Thus, other example embodiments may have different values. It is noted that similar reference numerals and letters refer to similar items in the figures, and once an item is defined for one figure, it is possible that it need not be further discussed for the other figures. The present disclosure introduces a solution that includes a campaign generator that harnesses the capabilities of a Language Model (LLM) to craft multiple rephrased versions of an existing campaign, each tailored to distinct target groups. This system adopts a cluster-based methodology in conjunction with feedback such as a Click-Through Rate (CTR) prediction model to not just generate but also direct revised campaigns towards specific reader segments. This approach establishes a feedback loop, which is beneficial in the continuous refinement of the campaign generator. By integrating statistical testing and reinforcement learning, the disclosed solution facilitates an iterative enhancement process, thereby bolstering the campaign generator's efficacy and yielding campaigns with improved CRTs. This solution delivers personalized and impactful campaigns that resonate with target populations, leading to heightened campaign success and increased customer engagement.

Addressing the challenges faced by businesses, the disclosed solution recognizes the complexity of crafting personalized and engaging messages for subscribers using basic analytics tools. The disclosed framework elevates campaign effectiveness by leveraging complex analysis, data enrichment, AI-driven customer understanding, and efficient utilization of Generative AI (GenAI). This approach empowers the businesses to unlock their full marketing potential, which might otherwise remain untapped due to the limitations of conventional tools.

The technical details of the disclosed system encompass several components working in concert to achieve the overarching goal of developing a campaign generator that is an LLM fine-tuned for rephrasing campaigns for specific populations. Starting with a general text-generator LLM, the disclosed solution employs a mechanism to create a human-feedback dataset. This dataset is beneficial for evaluating whether the rephrased campaigns outperform the original in terms of achieving a higher CTR. The operational pipeline of the disclosed solution includes identifying target groups, generating rephrased campaigns for each group, assessing the results using statistical tests, and fine-tuning the campaign generator based on this assessment. The outcome is a campaign generator that delivers customized and impactful campaigns, which in turn drive increased engagement and campaign success.

The process generally begins with modeling customer preferences prior to campaign generation. A clustering algorithm is utilized to identify specific target groups within the reader audience, using explicit features such as job titles, engagement metrics like click volume, and inferred attributes such as gender. A K-modes clustering algorithm is employed to partition readers into groups based on these explicit features, providing valuable insights for optimizing the campaign generator. Each target group is then characterized using a clustering approach (e.g., greedy approach), aiming to cover a predetermined portion of the cluster with the description. Additionally, a CTR prediction model, may be used to predict the likelihood of a reader clicking on a campaign. This model also serves to provide descriptions for clusters that lack characterization by utilizing latent representations of readers and campaigns.

During campaign generation, the system revises campaigns according to the clusters' descriptions. For each cluster, the campaign generator is fed a prompt that includes the original campaign and the cluster description. The CTR prediction model evaluates the rephrased campaign candidates, and the version that increases (e.g., maximizes) the CTR is selected. The system also aims to split the cluster into two parts to establish a feedback loop for further fine-tuning of the campaign generator, using the probability to click as a basis for creating the partition.

After the campaign is finalized, the system fine-tunes the campaign generator. A human-feedback dataset is created using a statistical test, such as the proportion test, to compare the CTRs of readers who received the revised campaign versus those who received the original. If the revised campaign's CTR is statistically higher, this indicates successful generation. The campaign generator is fine-tuned using reinforcement learning, which is an adaptive process that incorporates reward-based optimization. This iterative process strengthens the campaign generator by allowing it to learn from feedback data and adjust model parameters accordingly.

In comparison to existing systems, the disclosed system introduces various improvements such as the mechanism to create a rewards dataset for fine-tuning the LLM using statistical tests, and the combination of a CTR prediction algorithm to provide feedback for the LLM. These represent a departure from traditional methods, which typically involve fitting content to a reader based on previous engagements using various recommendation system algorithms. The disclosed system's new approach enhances the personalization and effectiveness of marketing campaigns, offering a competitive edge to businesses seeking to maximize their marketing efforts.

While the present disclosure has been described primarily on leveraging LLMs for text-based campaign generation, it is not limited to such applications. The disclosed solution is equally capable of adapting to other forms of content, such as video, images, and interactive media. For instance, the campaign generator could be integrated with Generative AI models that specialize in video production, enabling the creation of personalized video campaigns that cater to the preferences of different target groups. Similarly, image-generating models could be employed to design visually compelling advertisements that resonate with the audience's interests. The underlying principles of clustering, CTR prediction, and reinforcement learning-based fine-tuning are applicable across various content formats and AI technologies.

The present disclosure relates to a system and method for generating and optimizing marketing campaigns. More specifically, the disclosure describes a campaign management system that leverages a Large Language Model (LLM) to create multiple variations of an existing campaign tailored to specific target groups. The system employs a cluster-based approach and a click-through rate (CTR) prediction model to generate revised campaigns and for target readers, thereby creating a feedback loop for further fine-tuning of the LLM for future campaigns.

Before delving into the detailed descriptions of the figures, it may be beneficial to outline the benefits of the disclosed campaign management system. Additionally, it may be useful to consider the potential use cases that this system can address.

The campaign management system disclosed herein offers several benefits. By using a clustering algorithm, the system can identify specific target groups within a reader audience based on explicit features such as job title, engagement metrics like click volume, and inferred attributes like gender. This allows for the creation of customized campaigns that are more likely to resonate with the target audience, potentially leading to increased engagement and higher CTRs.

Furthermore, the system uses a CTR prediction model to assess the potential success of the generated campaigns. This model predicts the probability of a reader clicking on a given campaign, providing insights that can be used to select the campaign version that is expected to yield increased (e.g., maximum) CTR. This data-driven approach to campaign selection can lead to more effective marketing efforts and improved campaign success rates.

In addition, a fine-tuning mechanism may use reinforcement learning to improve the campaign generator based on feedback from the performance of the campaigns. This iterative process allows the system to learn from performance of past campaigns and adjust its parameters, accordingly, leading to continuous improvement in subsequent campaign generation and optimization.

Consider, for instance, a business that is planning to introduce a new product to the market and wants to launch a marketing campaign to promote it. The business could utilize the system by inputting the original campaign, which could be a basic outline of the product's features and benefits, along with the intended target audience. The system would then employ its clustering algorithm to identify specific target groups within the business's existing customer base. This identification process would be based on a variety of factors, such as past purchase behavior, engagement with previous campaigns, and demographic information to name a few. In other words, the system uses information in the original campaign and known customer data to determine the likely target audience. Once these target groups are identified, the system may utilize an LLM to generate revised campaign candidates for each group. These revised campaigns would be tailored to the specific characteristics and preferences of each target group, ensuring that the marketing message resonates with the audience.

The system may evaluate the candidates and select the campaign expected to have the desired (e.g., maximum) CTR. This selection process is data-driven, using a CTR prediction model to estimate the likelihood of each campaign's success. This ensures that the selected campaign is tailored to the audience while also being expected to drive the desired (e.g., maximum) engagement. After the campaign is launched, the system continues to work by collecting performance data. This data includes metrics such as CTR, conversion rates, and overall engagement levels to name a few. The system may compare the metrics of the original and revised campaigns, providing a clear picture of the effectiveness of the campaign revisions.

This feedback is used to fine-tune the LLM campaign generator. In other words, the system learns from the performance of each campaign, adjusting its algorithms and models to improve future campaign generation. This iterative process allows the system to continuously improve, leading to more effective campaigns over time. With more effective campaigns, the business could see higher customer engagement, leading to increased product awareness and interest. This could translate into increased sales for the business, making the new product launch a success.

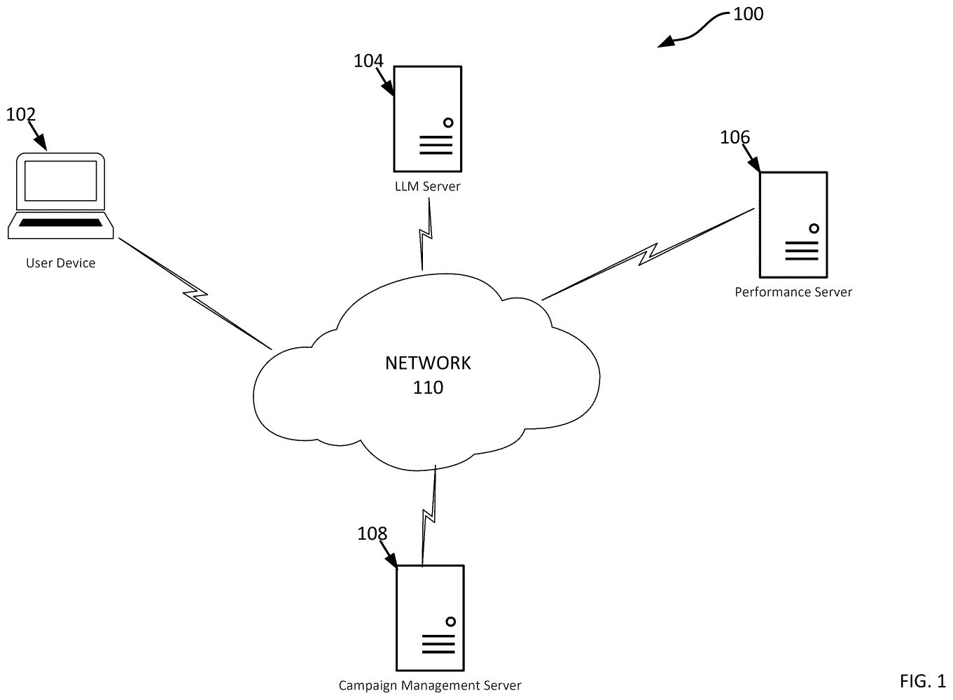

Referring now to FIG. 1, an example of a campaign generation and management system 100 according to the disclosed principles is now described. The illustrated system 100 includes a user interface device 102, a LLM server 104, a performance server 106, and a campaign management server 108, all interconnected via an interconnecting network 110.

The user interface device 102 may be any device capable of receiving user inputs and transmitting them to other components of the system 100. In some cases, the user interface device 102 may be a personal computer, a tablet, a smartphone, or any other suitable device. The user interface device 102 may be used to input the original campaign and target audience attributes into the system.

The LLM server 104 is configured to process the original campaign and generate revised campaign candidates. In some aspects, the LLM server 104 may fine-tune the LLM for rephrasing a campaign for a specific population. The LLM server 104 may generate multiple variations of the original campaign, each tailored to a specific target group identified within the reader audience.

The performance server 106 is configured to monitor the performance of the campaigns. In some cases, the performance server 106 may collect data on the CTRs of the original and revised campaigns, as well as other relevant performance metrics. This data may be used to create a human-feedback dataset for fine-tuning the campaign generator.

The campaign management server 108 oversees the overall campaign execution. In some aspects, the campaign management server 108 may execute a clustering algorithm to identify target groups within the reader audience based on features of the original campaign. The campaign management server 108 may also provide a description of each identified target group, predict the probability of a reader clicking on a given campaign using a CTR prediction model, and select a revised campaign that increases (e.g., maximizes) the predicted CTR. In some cases, the campaign management server 108 may be configured to increase the CTR of campaigns by using customers' previous engagements and their attributes.

The interconnecting network 110 facilitates the flow of information and commands between the user interface device 102, the LLM server 104, the performance server 106, and the campaign management server 108. The interconnecting network 110 may be any suitable network, such as a local area network (LAN), a wide area network (WAN), the internet, or any combination thereof.

In operation, a user inputs an original campaign and target audience attributes into the user interface device 102. The original campaign inputted by the user may range from a rudimentary outline of campaign ideas to a more structured campaign created by the user or synthesized by a generic LLM under direction of the user. The LLM server 104 processes this input and generate revised campaign candidates tailored to specific target groups. The campaign management server 108 may select the revised campaign that is predicted to have the desired (e.g., maximum) CTR and deploy it to the target audience. The performance server 106 monitors the performance of the campaigns and collect data for fine-tuning the campaign generator. This configuration allows for an iterative process of campaign generation, selection, deployment, and fine-tuning, leading to improved campaign success and customer engagement.

It is noted that the hardware devices shown in FIG. 1 may include various “modules” which may be hardware, software or a combination of both hardware and software. The disclosure references such modules when describing the functionality of the system.

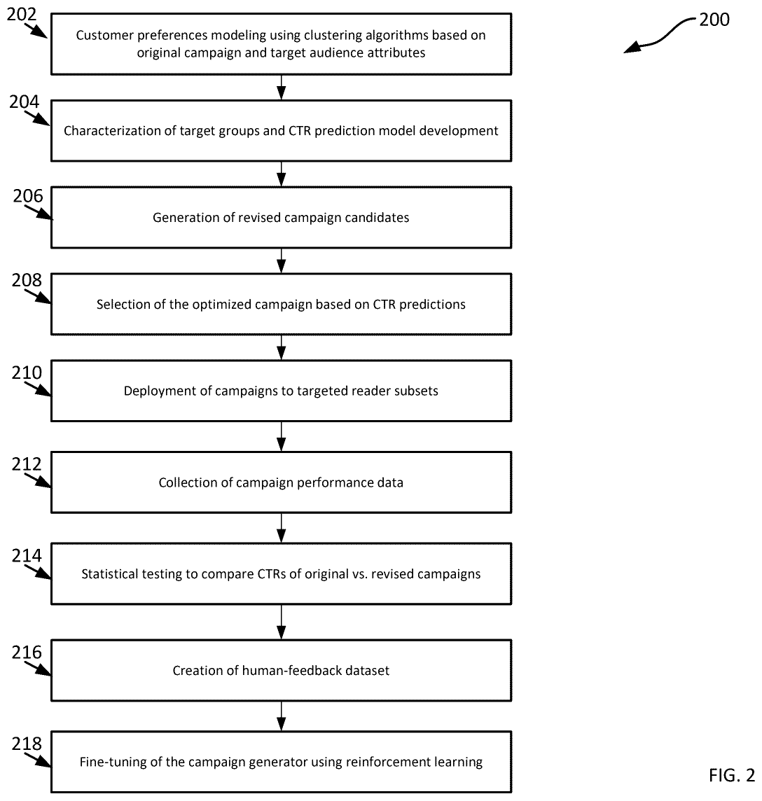

The operational details of the campaign management system will now be described with respect to the flowcharts illustrated in FIGS. 2-5. These figures illustrate example steps involved in optimizing campaign generation, identifying and characterizing target groups, revising campaigns based on these characterizations, and the feedback loop for improving the campaign generator. Each flowchart provides a visual representation of the processes that underpin the system's functionality, from the initial modeling of customer preferences to the fine-tuning of the campaign generator using reinforcement learning. These steps collectively contribute to the system's ability to generate personalized campaigns that are more likely to engage the target audience and achieve higher click-through rates, thereby enhancing the effectiveness of digital marketing efforts.

Referring now to FIG. 2, an example of an overall process 200 for optimizing a campaign generation process is depicted. The process 200 begins with the initial customer preferences modeling step 202, where the campaign management server 108 may use clustering algorithms based on the original campaign and target audience attributes to model customer preferences. In some cases, the clustering algorithm executed by the campaign management server 108 may be a K-modes clustering algorithm or the like. The initial customer preferences modeling step 202 involves identifying specific target groups within the reader audience based on explicit features such as job title, engagement metrics like click volume, and inferred attributes like gender. This may be achieved by analyzing a variety of explicit features that the readers have provided or that can be clearly inferred from their past on-line behavior. One such explicit feature is the job title, which can provide insights into the professional interests and industry-specific preferences of the readers. Another explicit feature that is considered is an engagement metric, such as click volume. Click volume refers to the number of times a reader has clicked on previous campaigns or content. This metric can provide a measure of the reader's level of interest and engagement with the content and can be a strong indicator of their likelihood to engage with future campaigns. In addition to these explicit features, the system also considers inferred attributes. One example of an inferred attribute may be gender, which can often be deduced from the reader's name or other available data. Gender can be a useful attribute for tailoring campaigns, as it can influence preferences and interests in many domains. By considering these and other explicit and inferred features, the system is able to identify specific target groups within the reader audience. This allows for the creation of more personalized and effective campaigns, tailored to the specific characteristics and preferences of each target group.

The process 200 proceeds to the target group characterization and CTR model development step 204. In this step, the campaign management server 108 provides a description of each identified target group via a characterization module. The characterization module of the campaign management server 108 may employ a greedy approach or the like to find the description of each identified target group. Additionally, the campaign management server 108 may predict the probability of a reader clicking on a given campaign using a CTR prediction model. In some aspects, the CTR prediction model of the campaign management server 108 may be a deep factorization machine.

After the target groups have been characterized and the CTR model has been developed, the process 200 moves to the revised campaign generation step 206. In this step, the campaign management server 108 generates revised campaign candidates for each target group based on the original campaign and the target group description using a campaign generator. The campaign generator of the campaign management server 108 may be an LLM fine-tuned for rephrasing a campaign for a specific population.

Once the revised campaign candidates have been generated, the process 200 advances to the optimized campaign selection step 208. In this step, the campaign management server 108 evaluates the revised campaign candidates using the CTR prediction model and select the campaign with the desired (e.g., maximum) predicted CTR. The CTR prediction model employed by the campaign management server 108 is a tool designed to estimate the likelihood of a reader engaging with a campaign by clicking on it. This model is part of the optimized campaign selection step 208, where it is used to evaluate the potential success of each revised campaign candidate generated by the system.

The CTR prediction model operates by analyzing a comprehensive set of features that may influence a reader's decision to click on a campaign. These features include, but are not limited to, demographic information, past engagement with similar campaigns, the content and design elements of the campaign itself, and the context in which the campaign is presented to the reader. To ensure accuracy and relevance, the CTR prediction model may incorporate machine learning techniques, such as deep learning or ensemble methods, which allow it to capture complex, non-linear interactions between the features. The chosen model is trained on historical campaign data, which includes both successful and unsuccessful campaigns, to learn patterns that are indicative of higher or lower CTRs. During the evaluation phase, the CTR prediction model assigns a score to each revised campaign candidate, reflecting the predicted probability of a click. The campaign management server 108 uses these scores to rank the candidates and select the one with the desired (e.g., maximum) predicted CTR for deployment. The CTR prediction model is updated with new data, allowing it to adapt to changing reader behaviors and preferences. This dynamic learning process is a cornerstone of the system's ability to generate increasingly effective campaigns over time.

Once the campaign with the desired (e.g., maximum) predicted CTR is chosen, the server 108 proceeds to the campaign deployment step 210, where it disseminates the campaign to the identified target groups within the reader audience. The deployment of the selected campaign is a strategic process managed by the campaign management server 108. This deployment is conducted through various digital marketing channels, such as email, social media, and online advertising platforms, ensuring that the campaign reaches the readers who are part of the target subsets. The deployment is timed and executed to increase (e.g., maximize) visibility and engagement, leveraging the insights gained from the CTR prediction model and the characterization of the target groups.

After the campaign has been deployed, the process 200 moves to the campaign performance data collection step 212 where the performance server 106 collects data on how the campaign performed. This data may be used in the subsequent CTR comparison statistical testing step 214 to compare the CTRs of the original versus the revised campaigns.

Performance data is collected through the performance server 106, which is configured to monitor various metrics that reflect the performance of both the original and revised campaigns. The server systematically gathers data on performance metrics, and user interactions with the campaign content. This collection process is automated and occurs in real-time, capturing data from the digital marketing channels where the campaigns are deployed. The collected data is aggregated and analyzed to create a comprehensive human-feedback dataset, which is beneficial in fine-tuning the campaign generator for future campaign iterations.

Based on the results of the CTR comparison, a human-feedback dataset may be created in the human-feedback dataset creation step 216. In some cases, the campaign management server 108 may be configured to generate the human-feedback dataset based on the performance of the revised campaign. Examples of the human-feedback dataset include aggregated data on click-through rates, conversion rates, and user engagement levels. This dataset may also contain qualitative feedback such as user comments, survey responses, and sentiment analysis from social media interactions. Additionally, the dataset could include A/B testing results, where different versions of a campaign are presented to different segments of the audience to determine which is more effective.

The process continues with campaign generator fine-tuning step 218 where a fine-tuning module of the campaign management server 108 uses reinforcement learning to fine-tune the campaign generator. This is an iterative process that allows the system to learn from past campaigns and adjust its parameters accordingly, leading to continuous improvement in campaign generation and optimization.

During the iterative process, the campaign management server 108 learns and adapts the campaign generator for improved performance. The fine-tuning module of the campaign management server 108 utilizes reinforcement learning algorithms that are designed to optimize the campaign generator's parameters based on the outcomes of previous campaigns.

During this process, the campaign management server 108 analyzes the collected campaign performance data, including metrics such as CTR, conversion rates, and engagement levels. The reinforcement learning algorithm identifies patterns and correlations between the campaign features and the observed performance metrics. Based on this analysis, the algorithm provides feedback signals to the campaign generator, indicating which aspects of the campaign were successful and which could be improved.

The campaign generator, equipped with this feedback, adjusts its content generation strategies, targeting mechanisms, and other operational parameters. For example, if the data indicates that a particular call-to-action phrase led to higher engagement rates, the campaign generator may be more likely to use similar phrases in future campaigns. Conversely, if a specific campaign design consistently results in lower CTRs, the generator may avoid such designs or modify them to test new variations.

The reinforcement learning algorithm operates on the reward maximization principle. It assigns rewards to actions that lead to positive outcomes, such as increased CTRs, and penalizes actions that do not contribute to campaign success. Over time, the campaign generator learns to prioritize actions that are more likely to yield higher rewards, effectively becoming more adept at producing successful campaign content.

This fine-tuning process is dynamic and ongoing, allowing the campaign management system to adapt to changes in user behavior, market trends, and other external factors. As the campaign generator becomes more sophisticated through reinforcement learning, it can generate campaigns that are increasingly personalized and effective, leading to a virtuous cycle of continuous improvement and higher ROI for marketing campaigns.

The process 200 is now described with respect to the following example where a business that specializes in eco-friendly household products is launching a new line of biodegradable cleaning supplies. The business aims to use the campaign management system to create a marketing campaign that targets environmentally conscious consumers who are likely to be interested in their products.

In this example, the business inputs the original campaign, which highlights the eco-friendly aspects of the new product line, into the user interface device 102. The original campaign includes a series of digital advertisements and email newsletters that emphasize the sustainability and natural ingredients of the cleaning supplies, as well as the company's commitment to reducing plastic waste. The intended target audience is defined by the user as individuals who have shown an interest in eco-friendly practices, such as subscribers to green living blogs, purchasers of organic products, and participants in environmental programs.

The campaign management server 108 executes a clustering algorithm to identify target groups within the business's customer base or accessible external customer databases. The algorithm analyzes customer data to find clusters based on explicit features such as purchasing habits of eco-friendly products, engagement metrics like responses to previous green initiatives, and inferred attributes such as lifestyle choices that suggest a preference for sustainable living.

Once the target groups are identified, the campaign management server 108 characterizes each group using a greedy approach to provide a detailed description that includes the group's defining features. For example, one target group may be characterized by its frequent purchases of organic products and its participation in local environmental events. Another group may be defined by its subscription to eco-friendly living magazines and its active engagement with online content related to sustainability.

The server employs a CTR prediction model to predict the likelihood of each group engaging with the campaign. The campaign generator, an LLM fine-tuned for creating content for specific populations, generates revised campaign candidates tailored to the characteristics of each target group. For instance, the revised campaign for the first group may include targeted messaging about the impact of the cleaning supplies on local ecosystems, while the campaign for the second group may focus on the health benefits of using natural cleaning products.

The campaign management server 108 evaluates these candidates using the CTR prediction model and selects the campaign with the desired (e.g., maximum) predicted CTR for deployment. The selected revised campaign for the first group might feature testimonials from local environmental activists, while the campaign for the second group could include endorsements from health and wellness influencers.

After the campaign is launched, the performance server 106 collects data on its performance, including CTR and engagement levels. This data is used to compare the effectiveness of the revised campaign against the original. The campaign management server 108 creates a human-feedback dataset based on this performance data, which is used to fine-tune the campaign generator using reinforcement learning.

Through this iterative process, the campaign generator learns which content resonates with the target audience, leading to more personalized and effective campaigns in the future. As a result, the business can expect to see higher engagement rates, increased awareness of their eco-friendly product line, and a boost in sales among environmentally conscious consumers.

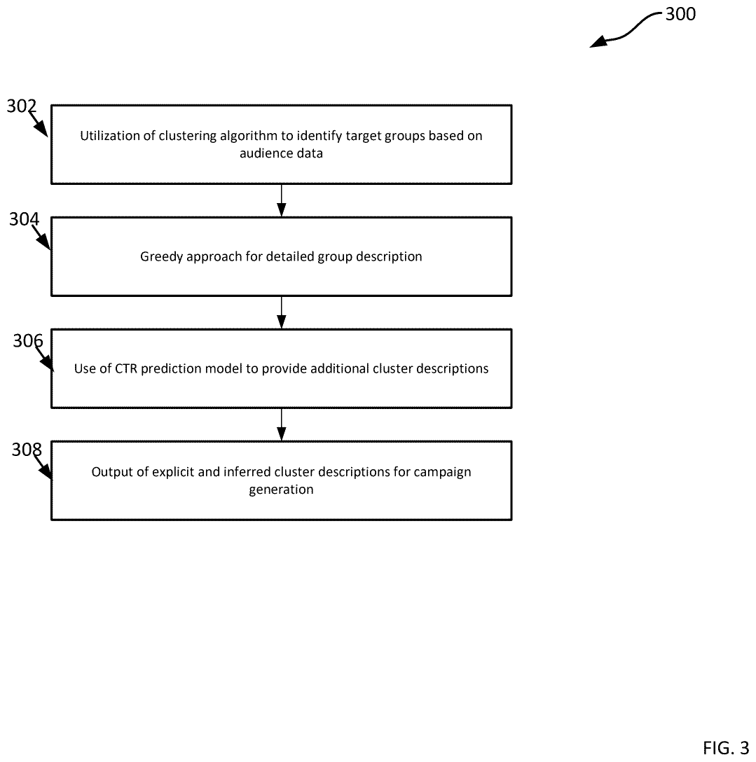

Referring now to FIG. 3, an example process 300 for customer preference modeling in the campaign management system is now described. This process 300 begins with the clustering algorithm step 302, where the campaign management server 108 executes a clustering algorithm to identify target groups within a reader audience based on features of the original campaign. In some cases, the clustering algorithm executed by the campaign management server 108 may be a K-modes clustering algorithm. This step involves identifying specific target groups within the reader audience based on explicit features such as job title, engagement metrics like click volume, and inferred attributes like gender.

It is noted that in the campaign management system, the user has the flexibility to directly input target audience information, which may include demographic data, behavioral patterns, and other relevant attributes that define the intended recipients of the campaign. This user-provided information is used by the system to identify and tailor campaigns to specific reader groups, ensuring that the content is relevant and engaging for the audience. Alternatively, the system is equipped with the capability to estimate the target audience based on the original campaign input by the user. The system can infer audience characteristics from the campaign's content, context, and historical engagement data. This inferred audience information allows the system to autonomously identify potential target groups, even in the absence of explicit user input, thereby streamlining the campaign creation process and enhancing the targeting accuracy of the marketing efforts.

The process 300 proceeds to the greedy approach for group description step 304 where the campaign management server 108 provides a detailed description of each identified target group. The characterization module of the campaign management server 108 may employ a greedy approach to find the description of each identified target group. This approach aims to cover a specified percentage of the cluster, starting with the feature that has the desired (e.g., maximum) coverage and adding features that cover the specified percentage of the remaining cluster members until no more features meet this criterion.

The process 300 advances to the CTR prediction model step 306 in which the campaign management server 108 predicts the probability of a reader clicking on a given campaign using a CTR prediction model. In some aspects, the CTR prediction model of the campaign management server 108 may be a deep factorization machine. This model predicts the probability of a reader clicking on a given campaign using the explicit features of the reader, the reader's past engagements (e.g., interaction history with previous campaigns, content engagement patterns, etc.), the campaign content, and context.

The process 300 continues with the cluster descriptions output 308, which represents the output of explicit and inferred cluster descriptions for campaign generation. The cluster descriptions, which may be either the explicit description from the greedy approach for group description 304 or the negative and positive campaigns from the CTR prediction model step 306, will be used as part of the prompt for the campaign generator.

In the context of the eco-friendly household products business, this modeling is beneficial in identifying and understanding the nuanced preferences of the target audience. The campaign management server 108 initiates this process by executing a clustering algorithm, such as a K-modes clustering algorithm, to segment the reader audience into distinct target groups. In this example, the groups are formed based on a combination of explicit features, such as purchasing habits and engagement metrics, and inferred attributes, like lifestyle choices indicative of a preference for sustainable living.

The campaign management server 108 crafts a comprehensive profile for each target group. This profile includes a rich set of characteristics that define the group, aiming to encapsulate the essence of the audience segment. For instance, one group may be characterized by their high engagement with eco-friendly content and a history of purchasing biodegradable products, while another may be distinguished by their active participation in environmental advocacy and a preference for organic living.

The campaign management server 108 employs a predictive model, such as a deep factorization machine, to estimate the likelihood of engagement with the campaign. The model takes into account the detailed group profiles, the content and context of the campaign, and historical engagement data to forecast the campaign's success. This predictive capability is part of the system's ability to select the revised campaign with the desired (e.g., maximum) predicted CTR, ensuring that the marketing efforts are not just targeted but also optimized for engagement.

The campaign generator is provided with the insights gleaned from the customer preferences modeling. These insights, encapsulated in the explicit and inferred cluster descriptions, inform the campaign generator's content creation, enabling it to produce campaigns that resonate deeply with the target audience. By leveraging the detailed understanding of customer preferences, the campaign management system facilitates the generation of marketing campaigns that are not just personalized but also primed for desired (e.g., maximum) impact, driving engagement and fostering a stronger connection between the eco-friendly brand and its environmentally conscious consumers.

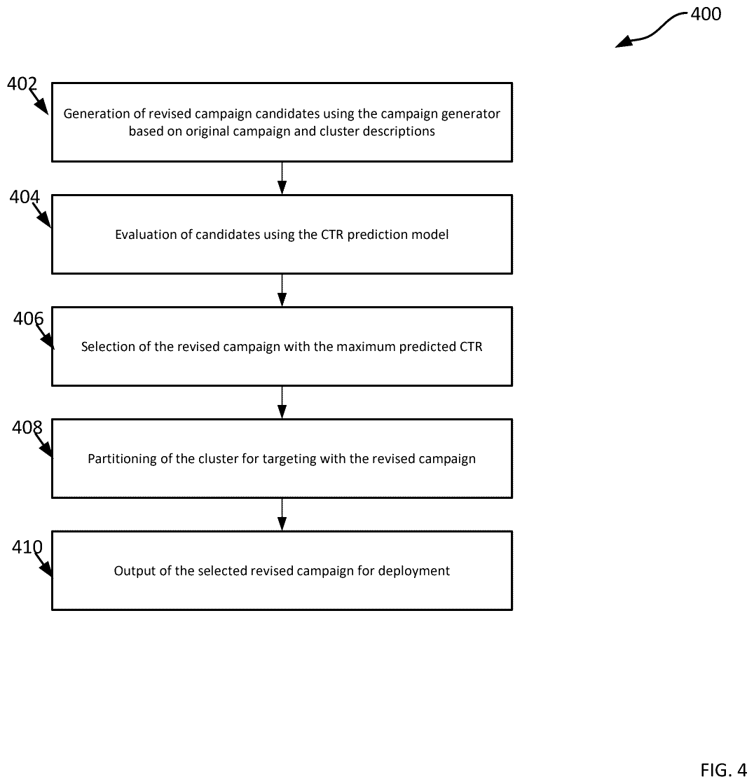

Referring now to FIG. 4, an example process 400 of campaign revisioning according to the clusters' descriptions in the campaign management system is now described. This process begins with the revised campaign generation step 402, where the campaign management server 108 generates revised campaign candidates for each target group based on the original campaign and the target group description using a campaign generator. In some aspects, the campaign generator of the campaign management server 108 may be an LLM fine-tuned for rephrasing a campaign for a specific population. This step involves creating multiple variations of the original campaign, each tailored to a specific target group identified within the reader audience.

In the campaign evaluation step 404, the campaign management server 108 evaluates the revised campaign candidates using the CTR prediction model to estimate their potential effectiveness. The CTR prediction model of the campaign management server 108 may be a deep factorization machine or any other suitable model that predicts the probability of a reader clicking on a given campaign using the explicit features of the reader, the reader's past engagements, the campaign content, and context.

In the revised campaign selection step 406, the campaign management server 108 selects the campaign with the desired (e.g., maximum) predicted CTR. The selection module of the campaign management server 108 may be configured to select the revised campaign that increases (e.g., maximizes) the predicted CTR. This step involves choosing the campaign version that is expected to yield the desired (e.g., maximum) CTR, thereby optimizing the campaign for the target audience.

In the cluster partitioning step 408, the campaign management server 108 partitions the cluster for targeting with the revised campaign, ensuring that the appropriate audience receives the optimized content. In some cases, the selection module of the campaign management server 108 may be configured to split the target group into two parts to create a feedback loop for further fine-tuning of the campaign generator. This step may involve creating a partition of the cluster based on the improvement of at least a specified percentage in the probability to click.

The process proceeds with revised campaign output step 410, which represents the output of the selected revised campaign, which is ready for deployment to the target audience. This step involves finalizing the selected revised campaign and preparing it for distribution to the target audience.

In the context of the eco-friendly household products business, the campaign generator leverages the detailed cluster descriptions to craft campaign variations that resonate with distinct audience segments. For instance, one variation may focus on the biodegradability and composability of the products to appeal to waste-conscious consumers, while another may underscore the non-toxic and safe-for-children nature of the products to attract health-oriented parents, ensuring that the campaign's messaging is congruent with the diverse values and interests within the eco-friendly community.

The campaign management server 108 utilizes the CTR prediction model, to evaluate the potential impact of each eco-centric campaign variation. By analyzing data points such as the frequency of eco-friendly purchases, interaction with past sustainability campaigns, and the environmental values inferred from consumer behavior, the model forecasts the engagement levels of each campaign. This analysis is beneficial in pinpointing the campaign variations that are poised for success among eco-conscious consumers.

With data-driven precision, the campaign management server 108 identifies and selects the campaign variation predicted to achieve the desired (e.g., maximum) CTR among the eco-friendly audience. This selection is informed by insights into the audience's engagement with environmental issues, ensuring that the chosen campaign is finely tuned to spark interest and drive action within the eco-conscious community.

To enhance the adaptive learning of the campaign generator, the campaign management server 108 strategically partitions the eco-conscious target group. This partitioning facilitates a controlled deployment of the campaign, enabling the collection of rich performance data from a focused subset of the audience. The insights gained from this data are beneficial in refining the campaign generator's ability to produce increasingly resonant and effective eco-friendly campaigns.

The campaign optimized for desired (e.g., maximum) relevance and impact within the eco-friendly sphere is now poised for launch. The campaign management server 108 orchestrates the distribution of the campaign to carefully selected segments of the eco-conscious audience, laying the groundwork for heightened engagement and a successful marketing endeavor that aligns with the ethos of sustainability.

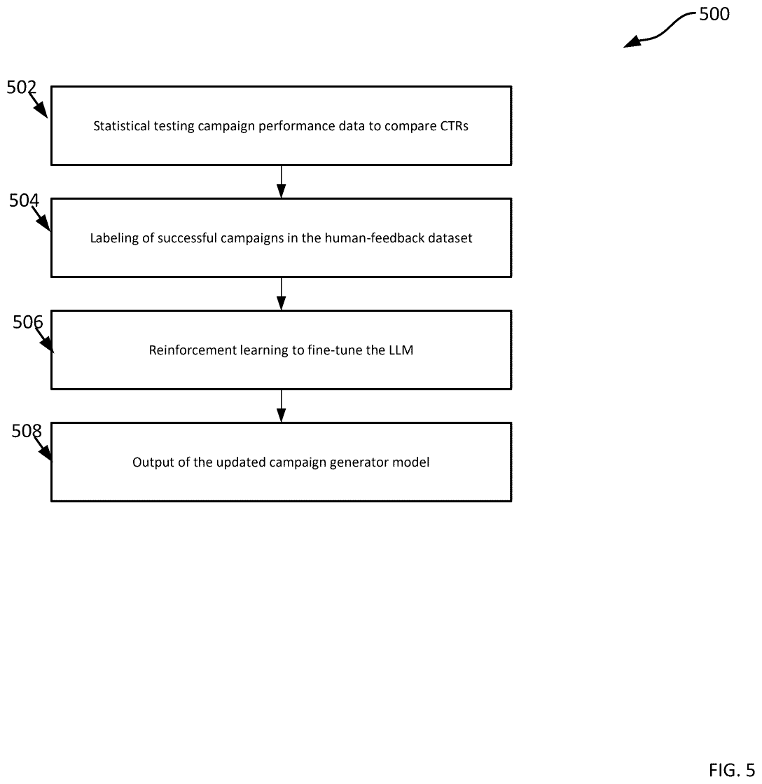

Referring now to FIG. 5, an example fine-tuning process 500 for an LLM used in campaign generation is now described. This process 500 begins with the statistical testing step 502, where the campaign management server 108 analyzes campaign performance data to compare CTRs. In some aspects, the fine-tuning module of the campaign management server 108 may use a statistical test, such as the proportion test, to compare the CTR of the readers that received the revised campaign versus those that received the original campaign. This step involves comparing the performance of the original and revised campaigns to assess the effectiveness of the campaign generator.

In the labeling feedback step 504, the campaign management server 108 identifies successful campaigns and label them within the human-feedback dataset. In some cases, the campaign management server 108 may be configured to generate the human-feedback dataset based on the performance of the revised campaign. This step involves creating a dataset that captures the performance of the campaigns, providing feedback for fine-tuning the campaign generator.

In the reinforcement learning step 506, the campaign management server 108 may fine-tune the LLM based on the feedback received. The fine-tuning module of the campaign management server 108 may use reinforcement learning to fine-tune the campaign generator. This step involves adjusting the parameters of the campaign generator based on the feedback from the performance of the campaigns, allowing the system to learn from past campaigns and improve future ones.

Some examples of feedback include CTRs: The number of times users click on a campaign link relative to the number of times the campaign is shown, providing a direct measure of campaign engagement; Conversion Rates: The percentage of users who take a desired action after clicking on a campaign, such as making a purchase, signing up for a newsletter, or downloading a resource; User Engagement Levels: Metrics such as time spent on a campaign landing page, interaction with campaign content, and social media shares, likes, and comments; Qualitative Feedback: User comments, reviews, and direct feedback collected through surveys, focus groups, or customer service interactions; A/B Testing Results: Comparative data from experiments where different versions of a campaign are presented to different segments of the audience to determine which is more effective; Sentiment Analysis: Insights derived from analyzing the sentiment of user-generated content on social media or feedback forms related to the campaign; Bounce Rates: The rate at which new visitors navigate away from the campaign landing page without taking action, indicating the relevance and effectiveness of the campaign content; Campaign Cost Metrics: Data on the cost-effectiveness of the campaign, including cost per click (CPC), cost per acquisition (CPA), and overall return on investment (ROI); —Heatmaps: Visual representations of where users click, move, and scroll on a campaign page, indicating areas of interest or potential confusion; and User Behavior Analytics: Data on user pathways through a website or app after engaging with a campaign, showing how the campaign influences overall user behavior.

The process 500 continues with the updated model output step 508, which represents the output of the improved campaign generator model, ready for deployment in future campaign generation tasks. In some aspects, the fine-tuning module of the campaign management server 108 may use the reinforcement learning to fine-tune the campaign generator. This step involves finalizing the updated campaign generator model and preparing it for use in generating future campaigns.

In keeping with the eco-friendly household products business scenario, the fine-tuning process not merely enhances the efficacy of the campaign generator but also ensures that the marketing strategies are increasingly aligned with the core values and interests of the eco-conscious consumer base. The campaign management server 108 scrutinizes the collected campaign performance data. By employing a statistical test, such as the proportion test, the server compares the CTRs of the audience segments that were exposed to the revised campaign against those that received the original campaign. The revised campaigns may be specifically designed to highlight the biodegradable nature of the products, the use of sustainable manufacturing processes, and the company's commitment to reducing plastic waste.

The campaign management server 108 identifies which of the revised campaigns outperformed the original, paying close attention to the messaging that emphasized the environmental benefits and ethical considerations of the products. These successful campaigns are then labeled within the human-feedback dataset, which is meticulously compiled based on the performance data. This dataset serves as a foundation for the reinforcement learning algorithms, capturing the nuances of campaign performance and providing a rich source of feedback for subsequent fine-tuning efforts. The feedback includes not just metrics but also qualitative data on customer sentiment and engagement with the eco-friendly aspects of the campaign.

With the feedback labeled, the campaign management server 108 leverages the insights from the human-feedback dataset to fine-tune the LLM campaign generator. The fine-tuning module employs reinforcement learning techniques to iteratively adjust the campaign generator's parameters. This learning approach is predicated on the principle of reward maximization, where the generator is progressively optimized to produce campaign content that is more likely to resonate with the target audience and achieve higher engagement rates. The updated model yields an enhanced version of the campaign generator, which now has a better understanding of the language and imagery that evoke a strong response from eco-conscious consumers.

This updated model embodies the learnings from previous campaign iterations and is primed for deployment in future campaign generation tasks. The fine-tuning module ensures that the campaign generator is not static but evolves continuously, improving its ability to craft compelling and effective campaigns that align with the shifting preferences and behaviors of the eco-conscious consumer base. The system's enhanced capability to generate content that reflects the latest trends in sustainability and environmental responsibility results in campaigns that not just sell products but also contribute to the brand's image as a leader in eco-friendly initiatives.

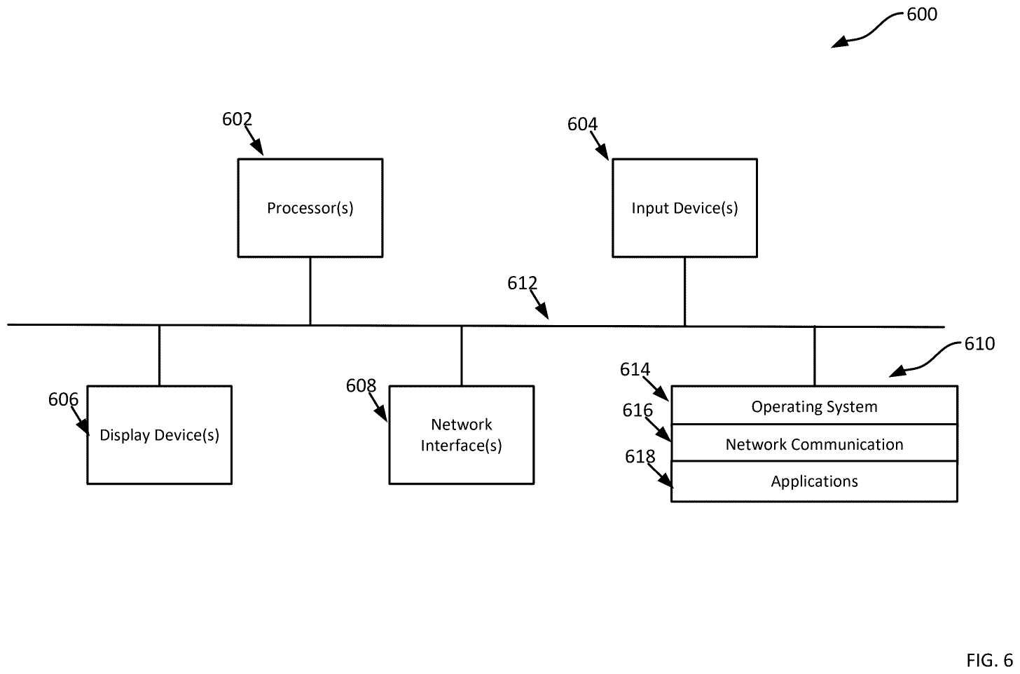

Referring now to FIG. 6, an example computing system diagram 600 is now described. The computing system diagram 600 represents a computing device that can be used to implement the campaign management system described herein. The computing system diagram 600 includes a processor 602, user input devices 604, visual output devices 606, network connectivity hardware 608, and system software 610. The processor 602, user input devices 604, visual output devices 606, and network connectivity hardware 608 are interconnected via a bus 612, which facilitates communication between these components.

The processor 602 may be any suitable processing unit or set of processing units, such as a microprocessor, a microcontroller, a digital signal processor, a personal computer, or any other device capable of manipulating or processing information. In some cases, the processor 602 may be configured to execute instructions stored in a memory (not shown) to perform various operations associated with the campaign management system, such as executing a clustering algorithm, generating revised campaign candidates, predicting CTRs, and fine-tuning the campaign generator.

The user input devices 604 may include any devices that allow a user to input information into the computing system diagram 600, such as a keyboard, a mouse, a touch screen, or a microphone. In some aspects, the user input devices 604 may be used to input the original campaign and target audience attributes into the campaign management system.

The visual output devices 606 may include any devices that provide visual information to a user, such as a monitor, a display screen, or a projector. In some cases, the visual output devices 606 may be used to display the results of the campaign generation process, such as the revised campaign candidates and the selected campaign.

The network connectivity hardware 608 may include any devices or components that enable the computing system diagram 600 to communicate with other devices or systems over a network. In some aspects, the network connectivity hardware 608 may facilitate the flow of information and commands between the user interface device 102, the LLM server 104, the performance server 106, and the campaign management server 108, as depicted in FIG. 1.

The system software 610 may include various software components that manage the operation of the computing system diagram 600. The system software 610 may include system operating software 614, network communication software 616, and software applications 618. The system operating software 614 may manage the overall operation of the computing system diagram 600, including managing the execution of other software components. The network communication software 616 may manage the communication between the computing system diagram 600 and other devices or systems over a network. The software applications 618 may include various applications that perform specific tasks, such as the campaign management system described herein.

In operation, a user may input an original campaign and target audience attributes into the computing system diagram 600 via the user input devices 604. The processor 602 may process this input and execute various operations associated with the campaign management system, such as generating revised campaign candidates, predicting CTRs, and fine-tuning the campaign generator. The results of these operations may be displayed to the user via the visual output devices 606. The network connectivity hardware 608 may facilitate the flow of information and commands between the computing system diagram 600 and other devices or systems, enabling the iterative process of campaign generation, selection, deployment, and fine-tuning.

While the foregoing is directed to example embodiments described herein, other and further example embodiments may be devised without departing from the basic scope thereof. For example, aspects of the present disclosure (e.g., modules) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are not limiting. It is intended that permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed:

1. A campaign management system, comprising:
a campaign management server configured to:
receive a first campaign,
execute a clustering algorithm to identify target groups within a reader audience based on features of the first campaign,
provide a description of each identified target group via a characterization module,
predict a probability of a reader clicking on a given campaign using a Click-Through Rate (CTR) prediction model,
generate revised campaign candidates for each target group based on the first campaign and the target group description using a campaign generator,
select a revised campaign that maximizes the predicted CTR with a selection module, and create a human-feedback dataset based on a performance of the revised campaign and fine-tune the campaign generator using a fine-tuning module with reinforcement learning; and
a performance server in communication with the campaign management server, configured to collect campaign performance data and facilitate creation of the human-feedback dataset for adjusting the reinforcement learning.

2. The campaign management system of claim 1, wherein the clustering algorithm executed by the campaign management server is a K-modes clustering algorithm.

3. The campaign management system of claim 1, wherein the characterization module of the campaign management server employs a greedy approach to find the description of each identified target group.

4. The campaign management system of claim 1, wherein the CTR prediction model of the campaign management server is a deep factorization machine.

5. The campaign management system of claim 1, wherein the campaign generator of the campaign management server is a Language Model fine-tuned for rephrasing a campaign for a specific population.

6. The campaign management system of claim 1, wherein the selection module of the campaign management server is configured to split the target group into two parts to create a feedback loop for further fine-tuning of the campaign generator.

7. The campaign management system of claim 1, wherein the fine-tuning module of the campaign management server uses a statistical test to compare the CTR of the readers that received the revised campaign versus those that received the first campaign.

8. The campaign management system of claim 1, wherein the fine-tuning module of the campaign management server uses the reinforcement learning to fine-tune the campaign generator.

9. The campaign management system of claim 1, wherein the campaign management server is configured to generate the human-feedback dataset based on the performance of the revised campaign.

10. The campaign management system of claim 1, wherein the campaign management server is configured to increase click-through rate of campaigns by using customers' previous engagements and their attributes.

11. A method for managing a campaign, comprising:
receiving a first campaign at a campaign management server;
executing a clustering algorithm by the campaign management server to identify target groups within a reader audience based on features of the first campaign;
providing a description of each identified target group via a characterization module of the campaign management server;
predicting a probability of a reader clicking on a given campaign using a Click-Through Rate (CTR) prediction model of the campaign management server;
generating revised campaign candidates for each target group based on the first campaign and the target group description using a campaign generator of the campaign management server;
selecting a revised campaign that maximizes the predicted CTR with a selection module of the campaign management server, and creating a human-feedback dataset based on a performance of the revised campaign and fine-tuning the campaign generator using a fine-tuning module with reinforcement learning of the campaign management server; and
collecting campaign performance data at a performance server in communication with the campaign management server and facilitating creation of the human-feedback dataset for adjusting the reinforcement learning.

12. The method of claim 11, wherein the clustering algorithm executed by the campaign management server is a K-modes clustering algorithm.

13. The method of claim 11, wherein the characterization module of the campaign management server employs a greedy approach to find the description of each identified target group.

14. The method of claim 11, wherein the CTR prediction model of the campaign management server is a deep factorization machine.

15. The method of claim 11, wherein the campaign generator of the campaign management server is a Language Model fine-tuned for rephrasing a campaign for a specific population.

16. The method of claim 11, wherein the selection module of the campaign management server is configured to split the target group into two parts to create a feedback loop for further fine-tuning of the campaign generator.

17. The method of claim 11, wherein the fine-tuning module of the campaign management server uses a statistical test to compare the CTR of the readers that received the revised campaign versus those that received the first campaign.

18. The method of claim 11, wherein the fine-tuning module of the campaign management server uses the reinforcement learning to fine-tune the campaign generator.

19. The method of claim 11, wherein the campaign management server is configured to generate the human-feedback dataset based on the performance of the revised campaign.

20. The method of claim 11, wherein the campaign management server is configured to increase click-through rate of campaigns by using customers' previous engagements and their attributes.
